(19) United States
(12) Patent Application Publication
(10) Pub. No.: US 2022/0167752 A1
(43) Pub. Date: Jun. 2, 2022

(54) Foot Pillow

(71) Applicant: Nancy A Shannon, Coeur d Alene, ID (US)

(72) Inventor: Nancy A Shannon, Coeur d Alene, ID (US)

(21) Appl. No.: 17/247,122

(22) Filed: Dec. 1, 2020

(51) Int. Cl. A47C 20/00; B32B 5/18; B32B 25/04; B32B 5/02; B32B 9/02

(52) U.S. Cl. CPC A47C 20/021; B32B 5/18; B32B 25/04; B32B 2479/00; B32B 9/025; B32B 2307/744; B32B 2307/304; B32B 5/02

(57) ABSTRACT

A foot pillow that is a flat cushion for the feet, an apparatus that consists of one or more layers that are combined into one unit that a person can put their feet on. To distinguish from prior art, this foot pillow has multiple strategic layers to elevate the feet from the floor or ground surface. This foot pillow is one to four inches in thickness. A reflective insulated layer is added to reflect the cold from the floor and the warmth of the feet. The top layer may be attached or can be removed for washing.

### BACKGROUND OF THE INVENTION

There are other foot pillows which are varied in their description and usefulness. However, there are none that meet the description to place your feet on, not in. Additionally, there are mats that protect the feet and reflect the heat, but there are none specifically for height and a combination of layers like this product. This is designed as an apparatus to keep the feet warm. It is a barrier between the cold floor and warm feet. People suffer from cold feet needlessly. This foot pillow is designed to help people feel more comfortable while working at their desks or wherever they may be sitting by keeping warmer overall. Cold feet can be a result of poor circulation, or disease, and many people are working at their desk for 8 hours with little activity to keep the blood flowing and keep warm. We have cushions for our chair, why not a cushion for our feet to rest on and be warm and comfortable. Scientists say we lose body heat from our extremities, having warm feet could lead to better health and not getting sick as much. This invention is especially needed for the elderly and sickly who have low immunity as it will help them stay healthy and warm throughout their day.

The problem is that a normal floor is very often cold, it can be carpet or hardwood or tile. This foot pillow will help keep feet warm and comfortable with a vapor barrier, a reflective layer and enough height to take advantage of the room temperature. Therefore, keeping the feet warmer than if they were sitting directly on the floor surface.

### BRIEF SUMMARY OF THE INVENTION

The general purpose of this foot pillow is to provide a resting place for feet, but also help the feet keep warm by combining strategic layers of different components that have specific functions. The four specific layers in this invention include a non-skid barrier; a thick layer of foam, rubber, or anything to offer height; a reflective layer/barrier and a cover that could be cloth, leather, plastic.

### BRIEF DESCRIPTION OF THE DRAWING FIGURES

FIG. 1 is a top elevation view
Showing the foot pillow can be all shapes and sizes

FIG. 2 is a side elevation

FIG. 3 is a side view, cut section

FIG. 4 is a side elevation, exploded view showing the specific layers and their construction

### DETAILED DESCRIPTION OF THE INVENTION

The general purpose of this foot pillow is to provide a resting place for feet that provide some protection and a warmth barrier. This has a unique purpose that results in a foot pillow which is not anticipated, obvious, suggested or even implied by prior art, either alone or in combination thereof.

To accomplish this, the foot pillow looks like it is one thick cushion. But actually, it is comprised of layers strategically placed to provide a barrier of warmth for the feet. The first layer (Layer 110) that touches the floor provides a water-resistant barrier and some texture that prevents unwanted sliding. The second layer (Layer 112) provides some distance between the cold flooring and the feet to take advantage of the temperature in the room. The second layer also adds cushion and comfort, it could be made of foam or rubber or anything to give the cushion height. The third layer (Layer 114) is a reflective layer to keep the top side warm or at minimum reflect the warmth that the feet already provide. The fourth layer (Layer 116) is a covering that may be cloth, leather, plastic, rubber, or any kind of covering. The fourth layer is for attractiveness and the function is a place for feet or shoes to rest, this will help to keep the feet static and not sliding. This fourth layer can be made to be removed and washed as needed.

### DETAILED DESCRIPTION OF THE DRAWINGS

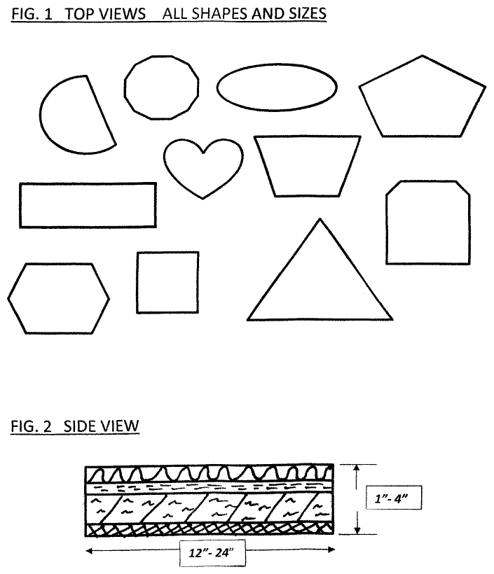

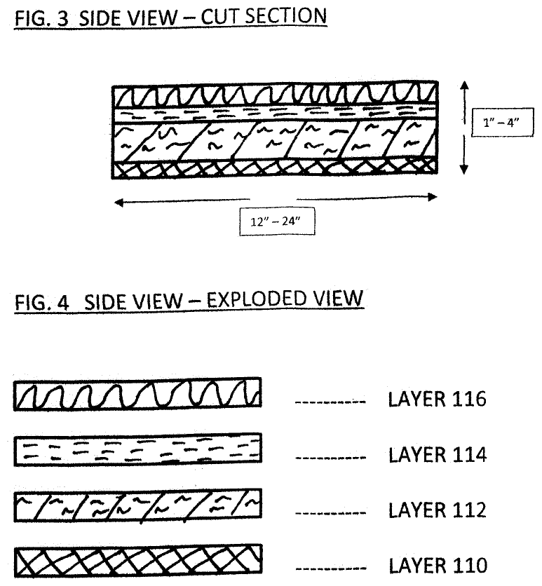

With reference now to the drawings, and in particular FIG. 1 shows many examples of the shapes that could be used. The shape would carry to each layer so from the top it looks like one piece. FIG. 2 shows a side view with the layers that are incorporated. FIG. 3 shows the exploded view of the inside of the layers from FIG. 2. FIG. 4 shows an exploded view of the layers. More specifically Layer 116 is the covering for the unit and may wrap over Layer 114.

Referring to FIG. 1: This shows top views in all shapes and sizes. The shapes could be varied for personality or different shape because of the shape needed for the foot area available.
Referring to FIG. 2: This shows each layer is different and each layer has a purpose.
Referring to FIG. 3: This layer is similar to FIG. 2, there is no difference when the piece is cut through and through.
Referring to FIG. 4: has a description of the layer details. Layer 110 details that this layer is non-slip and easy to clean, most likely black because it will be on the floor. Layer 112 can vary in composition and thickness, typically about 1 to 2 inches and can be made of foam or expanded rubber. This will provide the necessary height needed for the foot pillow. Layer 114 is a reflective layer about ¼″ inch thick to help keep the feet warm by reflecting the warmth back to the body (feet). Layer 116 is the top layer, made of cloth, vinyl, leather, or any covering. This layer can be removed, fastened, or glued. If it is removable, it would be for washing purposes. The color can vary on this top layer as different fabrics can provide different textures and color if needed for the rooms interior design.

What is claimed:

1. To distinguish from prior art this is a flat cushion for the feet, being comprised of one inch to four inches in thickness, in any shape with a reflective insulation layer.
